(19) United States
(12) Patent Application Publication
(10) Pub. No.: US 2002/0018945 A1
(43) Pub. Date: Feb. 14, 2002

(54) Exposure apparatus for multi-neck cathode ray tube and exposure method using the same

(76) Inventors: Eui-Jeong Hwang, Suwon-city (KR); Heung-Seob Lim, Suwon-city (KR)

Correspondence Address: STAAS & HALSEY LLP, 700 11TH STREET, NW, SUITE 500, WASHINGTON, DC, 20001, US

(21) Appl. No.: 09/878,315

(22) Filed: Jun. 12, 2001

(30) Foreign Application Priority Data
Jun. 13, 2000 (KR) 2000-32520

(51) Int. Cl. H01J 9/227

(52) U.S. Cl. 430/24; 445/60; 445/24

(57) ABSTRACT

An apparatus and a method for exposure for a multi-neck cathode ray tube, the exposure apparatus includes a panel supporting plate to support the face panel, light sources respectively mounted in each central position of the electron guns to radiate light beams and to generate an overlapped section on an inner surface of the face panel between a pair of the respective light sources, exposure lenses provided with the respective light sources to control optical paths of light beams emitted from corresponding light sources to follow paths of corresponding electron beams, and a plurality of exposure filters provided in front of the respective exposure lenses to control illumination distribution as a function of position and having light transmission characteristics reduced at an area corresponding to the overlapped section in order to maintain a uniform illumination distribution in the overlapped and non-overlapped sections.

### CROSS-REFERENCE TO RELATED APPLICATIONS

This application claims the benefit of Korea patent Application No. 2000-32520 filed on Jun. 13, 2000 in the Korean Industrial Property Office, the disclosure of which is incorporated herein by reference.

### BACKGROUND OF THE INVENTION

1. Field of the Invention

The present invention relates to an apparatus and a method for exposure suitable for manufacturing a multi-neck cathode ray tube, and more particularly, to an apparatus and a method for exposure in which light beams emitted from a plurality of light sources are controlled to reach a whole surface of a face panel with a uniform illumination distribution so that the resolution of a phosphor screen may be improved.

2. Description of the Related Art

In general, a cathode ray tube is a display for realizing a certain picture from light emitting on a phosphor screen by way of electron beams emitted from an electron gun. The electron gun should be mounted away from a center of the phosphor screen by a predetermined distance because a deflection yoke for deflecting electron beams is located between the electron gun and the phosphor screen. Thus, the cathode ray tube has a certain depth that is different from a flat display device, wherein the depth increases as the cathode ray tube becomes larger and flatter, and decreases by deflecting the electron beams over a wide angle.

The wide angle deflection of the electron beams, however, decreases the focusing characteristics in peripheral parts of a screen, degrading the quality of the image. In order to resolve this problem, conventional solutions, such as those proposed in U.S. Pat. No. 5,498,921 and U.S. Pat. No. 5,584,738, use a multi-neck cathode ray tube that includes a plurality of electron guns to scan a predetermined number of regions of the phosphor screen individually.

FIG. 1 is a cross-sectional view of a conventional multi-neck cathode ray tube, which includes a face panel 3 formed with a phosphor screen 1 on an inner surface, a funnel portion 7 coupled behind the face panel 3 and connected to a plurality of neck portions 5, a plurality of electron guns 9 mounted on an inner periphery of the respective neck portions 5 to emit electron beams, a plurality of deflection yokes 11 mounted on an outer peripheral surface of the funnel portion 7 opposite the respective electron guns 9 to generate a deflection magnetic field, and a shadow mask 13 mounted in the face panel 3 opposite the phosphor screen 1.

In the above structure, the phosphor screen 1 is provided with electron beams at divided areas corresponding to a number of the electron guns 9, and emits light there from. Thus, images realized by each of the areas are combined to form a single image so that a user sees a combined single image.

Even though the above multi-neck cathode ray tube is good for realizing a large-scale screen and reducing the depth, there are some problems in manufacturing. For instance, it is difficult to perform exposure during manufacture of the phosphor screen 1. The problems are due to the plurality of electron guns 9 being disposed such that a center part of the phosphor screen 1 receives peripheral parts (edges) of the electron beams emitted by respective electron guns 9.

The phosphor screen 1 includes a light absorbing layer, referred to as a “black matrix (BM)”, and a plurality of red R, green G, and blue B phosphor stripes which are manufactured by the well-known slurry process employing photolithography. The slurry process includes the coating a phosphor slurry 24 shown in FIG. 2 containing a photosensitive solution on the whole front surface of the face panel 3, exposing the phosphor slurry 24 using ultraviolet rays to form a phosphor layer, and developing the phosphor slurry 24 to remove any uncured remains of the phosphor slurry.

FIG. 2 is a schematic view of a conventional exposure apparatus of the surface exposing type, which is used in a conventional cathode ray tube having a single electron gun 9. A face panel 23 is coated with a predetermined phosphor slurry 24. A shadow mask 25 is mounted on the face panel 23, and the face panel 23 is mounted on a panel supporting plate 15. A mercury lamp serving as a light source 17 emits ultraviolet rays towards the phosphor slurry 24. The emitted ultraviolet rays pass through an exposure lens 19, and advance along a path coinciding with the path of electron beams emitted from the electron gun 9. While passing though an exposure filter 21, the ultraviolet rays are controlled in their light transmission amount as a function of position. The ultraviolet rays pass through the shadow mask 25 and reach predetermined positions to cure the phosphor slurry 24 at the predetermined positions.

If the exposure filter 21 is not used, the illumination distribution on an inner surface of the face panel 23 is inversely proportional to a distance from the face panel 23 to the light source 17. This relationship causes a peak in a center part of a screen 1 as shown in curve A of FIG. 3. The respective phosphor stripes, which are formed by the exposure process described above, have their size determined in proportion to the exposure strength. To resolve the imbalance due to the uneven illumination distribution as a function of position, the exposure filter 21 having light transmission characteristics varying as a function of position as shown in curve B is provided. Therefore, the ultraviolet ray emitted from the light source 17 reach the entire surface of the face panel with a uniform illumination distribution as shown in curve C, which is the sum of curve A and curve B.

As described above, if a single electron gun 9 is provided, the center of the electron beams from the electron gun 9 coincides with the center of the screen 1 so that the light source 17 is positioned in the center of the screen 1 to carry out the exposure process. However, for a multi-neck cathode ray tube provided with a plurality of electron guns 9 as shown in FIG. 1, the centers of the electron guns 9 do not coincide with the center of the light source 17 such that the exposure cannot be essentially carried out in accordance with the paths of the electron beams.

Even though it is possible to use the single light source 17 and to design the exposure lens 19 to focus the ultraviolet rays which are emitted from the light source 17 along a path coinciding with the paths of the electron beams that are emitted from a plurality of electron guns 9, there are some limits in time and expense to design and manufacture such an exposure lens 19. Also, even though it is possible to position respective light sources 17 in the centers of the plurality of electron gun positions, it is not possible to perfectly control the optical paths to project the light beams, which are emitted from corresponding light sources 17, to specific positions for the sake of the characteristics of the light beams. Thus, the light beams emitted from adjacent light sources 17 may be overlapped in the center of the screen 1. Therefore, an amount of light received by the inner surface of the face panel is rapidly increased in the center of the screen 1, increasing the size of the phosphor stripes in the overlapped areas of the center of the screen as shown in FIG. 4.

In contrast, if all the light beams emitted from the plurality of light sources 17 do not reach the center of the screen 1, the light amount received by the inner surface of the face panel becomes zero as shown in FIG. 5. In this case, the phosphor stripes are not formed in the center of the screen 1.

Accordingly, where the light sources 17 are positioned in the respective centers of the plurality of electron guns 9 as described above, the illumination distribution on the whole surface of the face panel 3 is not uniform, so that the phosphor stripes are not uniformly formed, and particularly, the picture quality of the center of the screen 1 is degraded.

### SUMMARY OF THE INVENTION

It is an object of the present invention to provide an apparatus and a method to expose a multi-neck cathode ray tube, in which respective light sources are mounted in center parts of a plurality of electron gun positions to perform exposure using light beams emitted along optical paths in common with electron beam paths of electron beams emitted from the electrode guns.

It is another object of the present invention to provide an apparatus and a method for exposure, in which light beams emitted from a plurality of light sources are controlled to be projected over an entire surface of a face panel with a uniform illumination distribution, thereby improving the picture quality of a phosphor screen.

Additional objects and advantages of the invention will be set forth in part in the description which follows and, in part, will be obvious from the description, or may be learned by practice of the invention.

In order to achieve the above and other objects of the present invention, an exposure apparatus to manufacture a multi-neck cathode ray tube includes a panel supporting plate to support a face panel, light sources respectively mounted in central positions corresponding to the positions of electron guns to radiate light beams and generate an overlapped section on an inner surface of the face panel between the respective adjacent light sources, exposure lenses to control paths of the light beams emitted from corresponding light sources follow corresponding electron beam paths followed by electron beams to be emitted from electron guns when mounted, and exposure filters provided in front of the respective exposure lenses to control a transmission amount of the light beams passing through portions of the exposure lenses as a function of position, wherein the exposure filters have reduced light transmission characteristics at an area corresponding to the overlapped section in order to maintain a combined light amount in the overlapped section to be the same as non-overlapped sections.

According to another embodiment of the present invention, a method of exposure to manufacture a phosphor screen of a multi-neck cathode ray tube includes mounting respective light sources, exposure lenses, and exposure filters in central positions corresponding to positions of a plurality of electron guns, emitting light beams from the light sources and forming an overlapped section on an inner surface of a face panel between the respective adjacent light sources, passing the light beams toward the face panel through the corresponding exposure lenses along electron beam paths followed by electron beams emitted by electron guns, controlling a light transmission amount as a function of position using the exposure filters, the respective exposure filters reducing an amount of transmitted light beams that reach the overlapped section to uniformly control an amount of the light beams that reach the inner surface of the face panel, and advancing the light beams to a certain position using a shadow mask to cure a slurry on the position reached by the light beams.

### BRIEF DESCRIPTION OF THE DRAWINGS

These and other objects and advantages of the invention will become apparent and more readily appreciated by reference to the following detailed description when considered in conjunction with the accompanying drawings wherein:

FIG. 1 is a cross-sectional view of a conventional multi-neck cathode ray tube;

FIG. 2 is a schematic view of a conventional exposure apparatus used to manufacture a conventional cathode ray tube having a single electron gun;

FIG. 3 is a graph showing an amount of light that reaches a face panel and a light transmission amount of the exposure filter in the conventional exposure apparatus of FIG. 2;

FIG. 4 and FIG. 5 are graphs showing an amount of light that reaches a face panel of a conventional multi-neck cathode ray tube using the conventional exposure apparatus;

FIG. 6 is a schematic view of an exposure apparatus for a multi-neck cathode ray tube according to an embodiment the present invention;

FIG. 7 is a graph showing an amount of light that reaches a face panel when no exposure filter is provided;

FIG. 8 and FIG. 9 are graphs respectively showing a light transmission amount of first and second exposure filters;

FIG. 10 is a graph showing a light transmission amount when the first and second exposure filters are combined; and

FIG. 11 is a graph of an amount of light that reaches a face panel using the embodiment of the present invention.

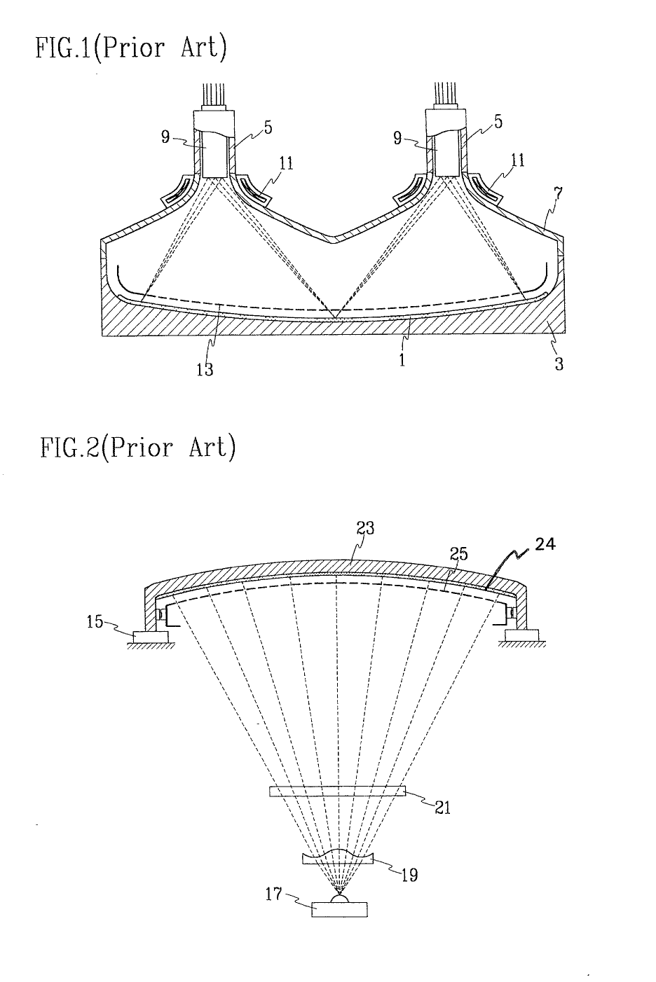

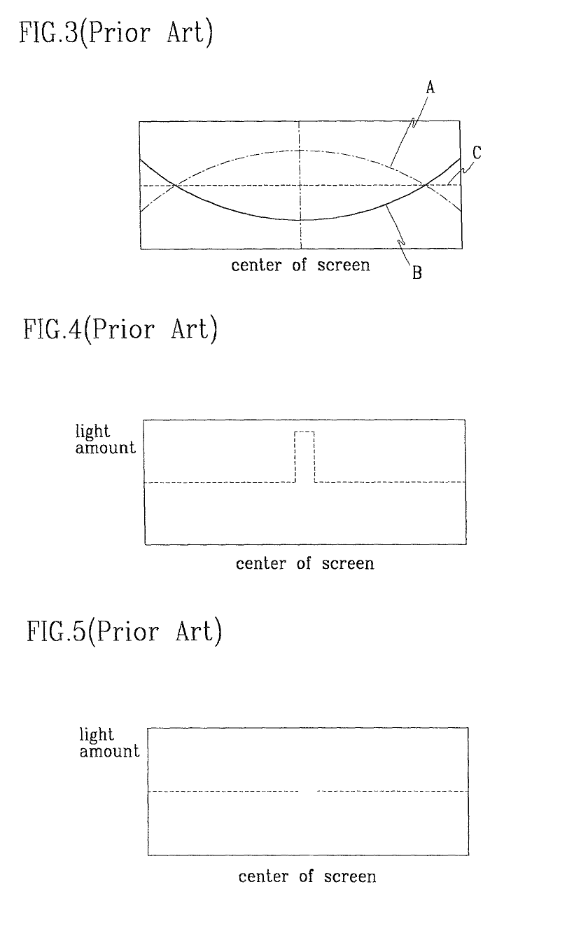

### DETAILED DESCRIPTION OF THE PREFERRED EMBODIMENTS

Reference will now be made in detail to the present preferred embodiment of the present invention, an example of which are illustrated in the accompanying drawings, wherein like reference numerals refer to the like elements throughout. The embodiment are described below in order to explain the present invention by referring to the figures.

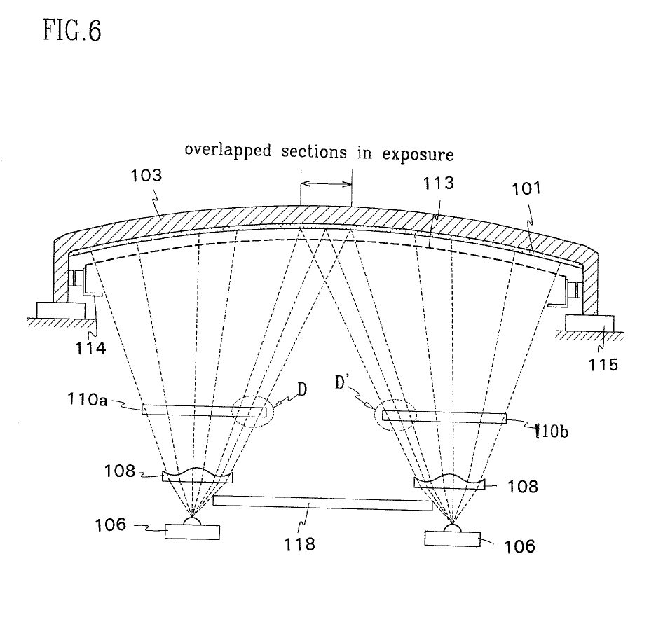

FIG. 6 is a schematic view of an exposure apparatus for a multi-neck cathode ray tube according to an embodiment of the present invention. In FIG. 6, an exposure apparatus includes a panel supporting plate 115 to support a face panel 103, a plurality of light sources 106 which are mounted in positions corresponding to centers of the electron gun positions, exposing lenses 108 mounted between respective light sources 106 and the face panel 103, and exposure filters 110a and 110b.

The face panel 103 is uniformly coated with a slurry 101 containing a photosensitive solution, and a shadow mask 113 is mounted inside the face panel 103 by a mask frame 114. The shadow mask 113 is formed with a plurality of beam passing apertures. The beam passing apertures are used to distinguish electron beams that are emitted from the electron guns, and to distinguish light beams that are emitted from the light sources 106 so as to project the emitted electron or light beams to predetermined positions.

The slurry 101 contains a photosensitive solution that is cured by the light beams to be firmly attached to an inner surface of the face panel 103. The light sources 106, radiate the light beams toward the face panel 103 to form phosphor stripes. The light sources 106 are provided in the center of the electron gun positions.

The shown light sources 106 are mercury lamps that emit ultraviolet rays having a wavelength of approximately 360 nm. Each of the exposing lenses 108 deflects the ultraviolet rays emitted from the corresponding light sources 106, and directs the ultraviolet rays along an optical path. Each optical path coincides with a path followed by electron beams emitted from the electron gun disposed at the center of the electron gun position at which the light source 106 is located. Each of the exposure filters 110a and 110b controls a light transmission amount of the ultraviolet rays as a function of position along the face panel 103.

An interference-blocking block 118 is mounted between the two light sources 106 to prevent interference between the ultraviolet rays emitted from adjacent light sources 106.

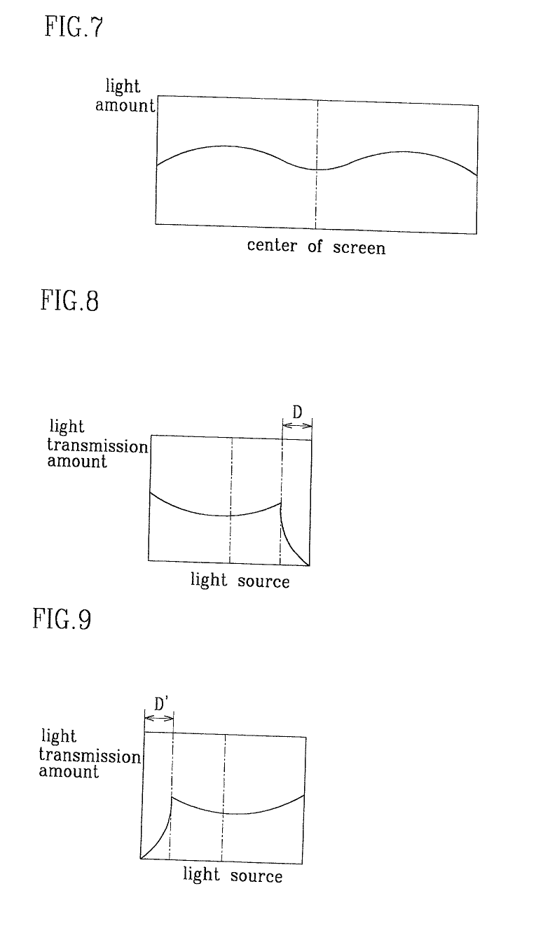

If two light sources 106 are mounted for a single face panel 103, the center of a screen corresponds to a peripheral part of the respective adjacent light sources 106. Thus, as shown in FIG. 7, when the exposure filters 110a and 110b are not used, an amount of light received by an inner surface of the face panel 103 decreases gradually from the center of the respective light sources 106 toward the peripheral part. Therefore, in order to prevent an imbalance in a size of the phosphor stripes due to the difference of light amount received by the slurry 101, the exposure filters 110a and 110b are provided to control a light transmission amount as a function of position. This results in an amount of the light beam passing though the exposure filters 110a and 110b being greater at the peripheral part than at the center part for the respective light sources 106.

However, due to the difficulty in completely isolating the emitted light beams into corresponding specific areas of the face panel 103 using interference blocking block 118 alone, the optical paths of light beams from the light sources 106 overlap at a section in the center of the screen. The light transmission characteristics in areas D and D′ are reduced. The areas D and D′ correspond to the overlapped sections of the exposure filters 110a and 110b, through which the light beams to be projected to the overlapped section pass.

In other words, the optical paths for the light beams pass through the areas D and D′ of the exposure filters 110a and 110b so as to overlap each other in the overlapped section in the face panel 103.

FIG. 8 and FIG. 9 are graphs respectively showing the light transmission characteristics of the first and second exposing filters 110a and 110b that are respectively positioned at the left and right sides in FIG. 6. The first and second exposure filters 110a and 110b exhibit parabolic shaped light transmission amount curves, of which the left and right parts are symmetrical with relation to the centers of the light sources 106 over the entire area. However, the curves are not symmetrical at the areas D and D′ corresponding to the overlapped sections of the filters 110a and 110b.

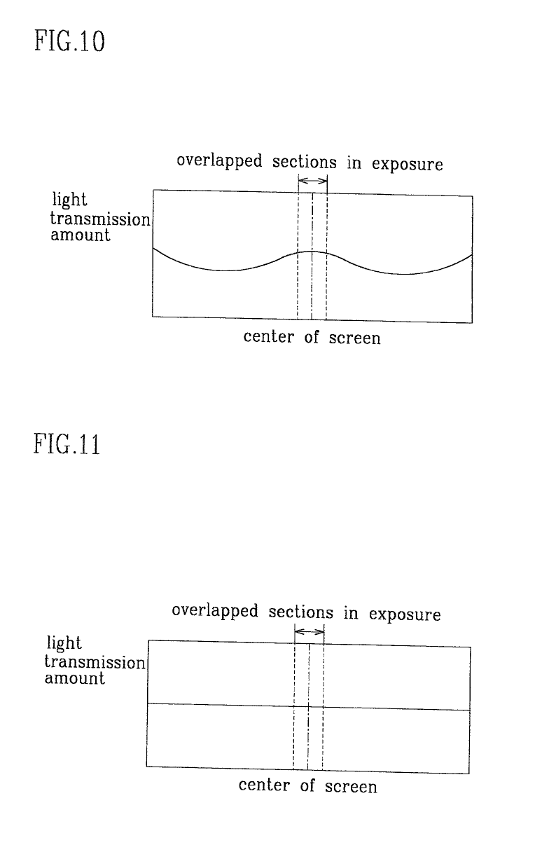

The curves for the areas D and D′ exhibit a rapidly reduced light transmission amount. FIG. 10 shows a light transmission amount curve in which the areas D and D′ of the first and second exposure filters 110a and 110b are overlapped as if used in a single exposure filter. The resulting light transmission curve in the combined state has a peak of a predetermined height in the center in order to resolve the imbalance of the light amount that is received by the center of the face panel 103 due to the overlapped section. Based on this predetermined height, the respective exposure filters 110a and 110b exhibit a light transmission curve which is gradually decreased from a center toward a periphery of the respective light sources 106 in the areas D and D′. This results in a combined light transmission amount equal to the overlapped section shown in FIG. 10. For instance, the respective exposure filters 110a and 110b have the light transmission curve in a reversed shape with relation to a horizontal axis regarding the entire parabolic curve in the areas D and D′ corresponding to the overlapped sections as shown in FIGS. 8 and 9.

The exposure filters 110a and 110b is made of a soda-lime glass. The light transmission amount may be controlled by differentiating a density of a substance to be coated and evaporated on the glass substrate, or by controlling a thickness of a chrome coated on the glass substrate by etching the chrome with a laser plotter, wherein the light transmission amount is increased as the thickness of the chrome is decreased.

Therefore, a light amount that the face panel 103 receives shows the uniform characteristics with relation to the entire surface of the face panel 103 as shown in FIG. 11. Since the light amount is uniform between overlapped and non-overlapped sections, the respective phosphor stripes are evenly cured to make the size characteristics of the stripes uniform.

As shown in FIGS. 8 and 9, the respective exposure filters 110a and 110b exhibit a light transmission curve that is gradually decreased from the areas D and D′ corresponding to the overlapped sections toward the periphery. This decrease is so that the difference in the light amount received at the inner surface of the face panel 103 (i.e., in the center of the screen) is effectively resolved, and the light beams emitted from the respective light sources 106 may be controlled to be projected to the face panel 103 with a uniform illumination distribution.

According to the present invention, a difference of light amount in the center of the screen may be prevented. Further, the light amount projected to the center of the screen may be controlled in an allowable range in spite of changes in exposing condition, such as changes in position of the light sources, thereby improving the quality of the phosphor screen.

Even though two light sources are used in the above embodiment of the present invention, it is understood that more than two light sources may be used corresponding to the number of electron guns in the case of the multi-neck cathode ray tube having more than two electron guns. The light amount projected to the face panel may be uniformly controlled by controlling the individual light transmission characteristics of the exposure filters after setting the overlapped sections between respective all light sources.

It will be apparent to those skilled in the art that various modifications and variations can be made to the device of the present invention without departing from the spirit and scope of the invention. The present invention covers the modifications and variations of this invention provided they come within the scope of the appended claims and their equivalents.

What is claimed is:

1. An exposure device to manufacture a phosphor screen on a face panel of a multi-neck cathode ray tube, comprising:
a panel supporting plate to support the face panel;
light sources mounted in central positions corresponding to center positions of electron guns, adjacent said light sources to radiate light beams and to generate an overlapped section on an inner surface of the face panel;
exposure lenses provided between the face panel and respective said light sources to control paths of the light beams emitted from respective said light sources, each path corresponding to an electron path followed by electron beams emitted by the corresponding electron gun; and
exposure filters provided between the face panel and the respective exposure lenses to control a transmission amount of light beams passing through said exposure lenses as a function of position, wherein
said exposure filters have reduced light transmission characteristics at an area corresponding to the overlapped section such that the transmission amount is the same at the overlapped section as in non-overlapped sections.

2. The exposure device of claim 1, wherein each said exposure filter has a symmetrical light transmission amount curve which increases gradually from a center toward a periphery of said exposure filter except at an area corresponding to the overlapped section.

3. The exposure device of claim 1, wherein each said exposure filter has a light transmission amount curve which decreases gradually toward a periphery of said exposure filter at the area corresponding to the overlapped section.

4. The exposure device of claim 1, wherein said exposure filters have a combined light transmission amount curve having a peak at the area corresponding to the overlapped section.

5. The exposure device of claim 1, wherein each of said exposure filters comprises a soda-lime glass coated with chrome, wherein a thickness of the chrome controls the light amount transmitted through said exposure filter.

6. The exposure device of claim 5, wherein the thickness of the chrome decreases gradually toward a periphery of said exposure filter at the area corresponding to the overlapped section.

7. The exposure device of claim 1, further comprising blocks respectively disposed between the adjacent said light sources to prevent interference between the light beams emitted from the adjacent said light sources.

8. A method of exposure to manufacture a phosphor screen of a multi-neck cathode ray tube, comprising:
mounting respective light sources, exposure lenses and exposure filters in central positions corresponding to the positions of electron guns used to emit electron beams;
emitting light beams from the light sources and forming an overlapped section on an inner surface of a face panel;
passing the light beams toward the face panel using the exposure lenses along electron paths, where the electron beams emitted from the electron guns to be mounted follow the electron paths;
controlling a light transmission amount as a function of position using the exposure filters, the exposure filters reducing an amount of transmitted light beams that reach the overlapped section to uniformly control the light transmission amount of the light beams that reach the inner surface of the face panel; and
controlling the light beams to be incident at a certain position of the inner surface of the face panel using a shadow mask to cure a slurry at the certain position.

9. The method of claim 8, wherein each of the exposure filters have light transmission amount curves which decrease gradually toward a periphery of the exposure filter at the area corresponding to the overlapped section.

10. The method of claim 8, wherein the exposure filters have a combined light transmission amount curve having a peak at the area corresponding to the overlapped section.

11. The method of claim 8, wherein one of the respective exposure filters are formed of a soda-lime glass that is coated with chrome, wherein a thickness of the chrome decreases gradually toward a periphery of the exposure filter at the area corresponding to the overlapped section to gradually decrease the light transmission amount.

12. The method of claim 8, wherein blocks are disposed between adjacent ones of said light sources to prevent interference of the light beams emitted from the adjacent light sources.

13. An exposure device to manufacture a phosphor screen of a multi-neck cathode ray tube having electrode guns mounted at electrode gun positions, comprising:
light sources to emit light beams on an inner surface of a face panel, two of the light beams having an overlapping area on the inner surface;
exposure lenses disposed between the face panel and respective said light sources to control the light beams to follow corresponding light paths to the inner surface; and
exposure filters disposed between the face panel and said exposure lenses to filter an intensity of the incident light beams such that the light intensity is substantially uniform over the face panel.

14. The exposure device of claim 13, wherein each light path is in common with a corresponding electron beam path followed by an electrode beam emitted from the electron gun when mounted at the corresponding electrode gun position.

15. The exposure device of claim 13, wherein said exposure filters, in combination, comprise a light intensity amount curve having a peak at an area corresponding to the overlapping area on the inner surface.

16. The exposure device of claim 15, wherein the peak is sufficient such that a light intensity at the overlapping area on the inner surface is uniform with light intensity of areas adjacent to the overlapping area.

17. The exposure device of claim 13, further comprising a shadow mask disposed between the inner surface and said exposure filters, said shadow mask to control light beams to reach predetermined areas of the inner surface.

18. The exposure device of claim 17, wherein the light intensity is uniform as to evenly cure a slurry coated on the face plate to define phosphor stripes.
